(19) United States
(12) Patent Application Publication
(10) Pub. No.: US 2010/0125658 A1
(43) Pub. Date: May 20, 2010

(54) METHOD AND SYSTEM FOR MULTIMEDIA CONTENT CONSUMPTION ANALYSIS

(75) Inventor: Jeffrey L. Strasters, Arlington, TX (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/272,594

(22) Filed: Nov. 17, 2008

(51) Int. Cl. G06F 15/173

(52) U.S. Cl. 709/224

(57) ABSTRACT

A method and system for analyzing consumption of multimedia content provided by a multimedia content delivery network are disclosed. The multimedia content may be selected by a user using an electronic programming guide on customer premises equipment (CPE). A historical log of content selection events may be recorded. The historical log is analyzed to generate consumption statistics and consumption patterns for the user. The consumption statistics may be generated for different content types. The analysis may be performed locally on CPE or by a remote server. The consumption statistics may be compared with a user subscription for multimedia content. A consumption metric may be generated for recommending a more cost-effective subscription package to the user. Consumption data may be provided to third parties for data mining.

### BACKGROUND

1. Field of the Disclosure

The present disclosure relates to multimedia content delivery networks and, more particularly, to analyzing consumption of multimedia content.

2. Description of the Related Art

Users of multimedia content delivery networks (MCDNs) select multimedia content available for consumption. The multimedia content may be selected as part of a package available to the user.

### BRIEF DESCRIPTION OF THE DRAWINGS

FIG. 1 is a block diagram of selected elements of an embodiment of a multimedia distribution network;

FIG. 2 is a block diagram of selected elements of an embodiment of a multimedia distribution network;

FIG. 3 is a block diagram of selected elements of an embodiment of a multimedia handling device;

FIG. 4 illustrates an embodiment of a method for analyzing consumption of multimedia content; and

FIG. 5 illustrates an embodiment of a method for analyzing consumption of multimedia content.

### DESCRIPTION OF THE EMBODIMENT(S)

In one aspect, a disclosed method for analyzing multimedia content provided by a MCDN includes collecting historical events describing multimedia content selected by a user of the MCDN, and analyzing the historical events to generate consumption statistics. The method may further include storing the consumption statistics, and enabling the display of the consumption statistics. The MCDN may be an Internet protocol (IP) compliant network. In certain instances, the collecting, analyzing, and enabling are performed by customer premises equipment (CPE). The user may select multimedia programs using an electronic programming guide (EPG), while the consumption statistics may be accessible using the EPG.

In some embodiments, the method may further include analyzing said historical events including classifying the selected multimedia content based on content type. evaluating the consumption statistics with respect to an MCDN subscription package, and generating a consumption metric based at least in part on said evaluating, wherein the consumption metric indicates a relationship between the consumption statistics and the MCDN subscription package. The method may further include recommending a modification of the MCDN subscription package to the user based on the consumption metric. The consumption metric may indicate at least one of undersubscribed, oversubscribed, or adequately subscribed multimedia content.

In some cases, analyzing the historical events may include classifying the selected multimedia content based on content type. The content type may be selected from the group consisting of: channel, channel type, intended audience, genre, duration, time of broadcast, and program ratings. The channel type may be at least one of: pay per view (PPV), video on demand (VOD), and scheduled programming.

In another aspect, a disclosed device, configured to analyze multimedia content provided by an MCDN, includes a processor, a network interface configured to receive multimedia content from the MCDN, and memory media accessible to the processor, including processor executable instructions. The instructions may be executable to record multimedia content user selection events to a historical consumption log, process the historical consumption log to reveal user consumption patterns, and display information visually indicative of the user consumption patterns. The device may further include a display device, and processor executable instructions to display a comparison of the user consumption patterns and an MCDN subscription package purchased by the user.

In some embodiments, an EPG of the MCDN may be used to generate the user selection events. An EPG of the MCDN may be used to display the information visually. The comparison may be made available by accessing the EPG. A result of the comparison may be at least one of undersubscribed, oversubscribed, or adequately subscribed multimedia content.

In some implementations, the processor executable instructions to process the historical consumption log may include instructions executable to send the historical consumption log to a remote server for analysis, and receive results of the analysis from the remote server, wherein the results include user consumption patterns. The processor executable instructions to process the historical consumption log include instructions executable to analyze the historical consumption log locally using the processor.

In yet another aspect, a disclosed computer-readable memory media includes program instructions for analyzing multimedia content provided to a user via an MCDN. The program instructions may be executable to receive a historical consumption log, wherein the historical consumption log includes information indicative of which multimedia content was selected for viewing by the user, analyze the historical consumption log and generate content consumption data based on the analysis, and analyze the historical consumption log using the processor. The program instructions may further be executable to send the content consumption data to a client of the MCDN.

In some cases, the content consumption data may include a comparison of actual consumption by the user with an MCDN subscription package purchased by the user. The comparison may further include a monetary difference between the value of the actual consumption and the value of the subscription package. The comparison may still further include information about different categories of multimedia content, while the categories of content may be selected from the group consisting of: channel, channel type, intended audience, genre, duration, time of broadcast, and program ratings.

In some embodiments, the memory media further includes instructions executable to include the content consumption data in an EPG provided to the client. The instructions may still further be executable to provide the content consumption data to a third party for data mining.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

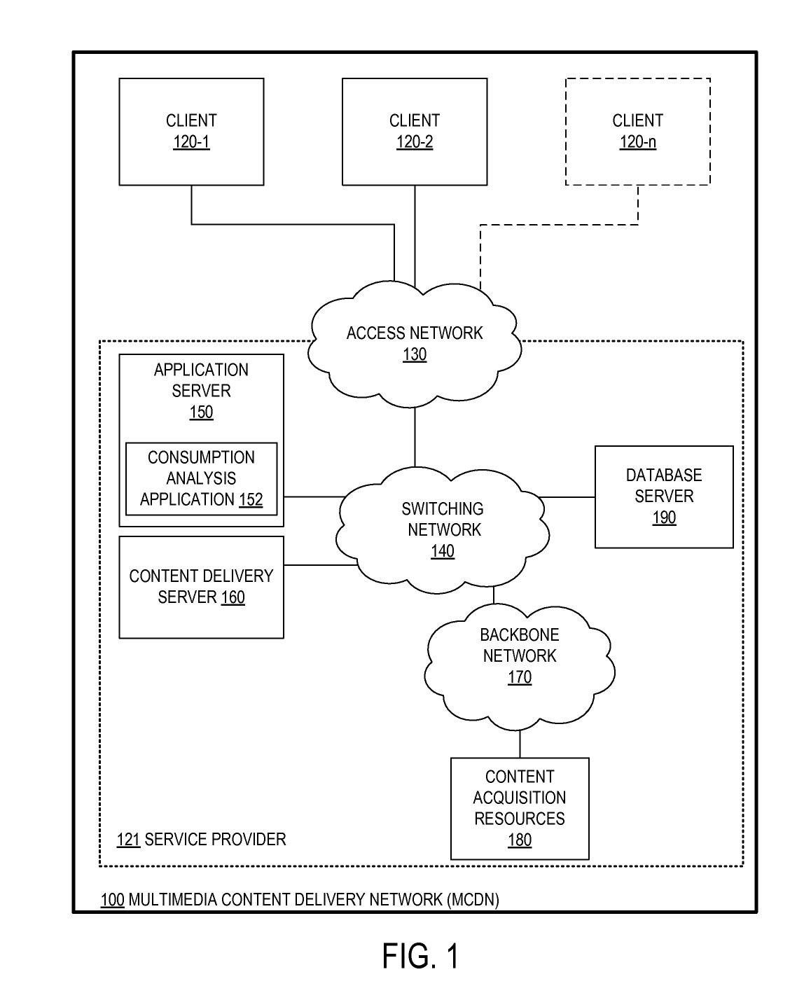

Turning now to the drawings, FIG. 1 is a block diagram illustrating selected elements of an embodiment of MCDN 100. Although multimedia content is not limited to TV, VOD, or PPV programs, the depicted embodiments of MCDN 100 and its capabilities are primarily described herein with reference to these types of multimedia content, which are interchangeably referred to herein as multimedia content, multimedia content program(s), multimedia programs or, simply, programs.

The elements of MCDN 100 illustrated in FIG. 1 depict network embodiments with functionality for delivering multimedia content to a set of one or more users. It is noted that different embodiments of MCDN 100 may include additional elements or systems (not shown in FIG. 1 for clarity) as desired for additional functionality, such as data processing systems for billing, content management, customer support, operational support, or other business applications.

As depicted in FIG. 1, MCDN 100 includes one or more clients 120 and a service provider 121. Each client 120 may represent a different user of MCDN 100. In FIG. 1, a plurality of n clients 120 is depicted as client 120-1, client 120-2 to client 120-n, where n may be a large number. Service provider 121 as depicted in FIG. 1 encompasses resources to acquire, process, and deliver programs to clients 120 via access network 130. Such elements in FIG. 1 of service provider 121 include content acquisition resources 180 connected to switching network 140 via backbone network 170, as well as application server 150, database server 190, content delivery server 160, also shown connected to switching network 140, and may further include a wireless server (not depicted).

Access network 130 demarcates clients 120 and service provider 121, and provides connection path(s) between clients 120 and service provider 121. In some embodiments, access network 130 is an IP compliant network. In some embodiments, access network 130 is, at least in part, a coaxial cable network. It is noted that in some embodiments of MCDN 100, access network 130 is owned and/or operated by service provider 121. In other embodiments, a third part may own and/or operate at least a portion of access network 130.

In IP-compliant embodiments of access network 130, access network 130 may include a physical layer of unshielded twisted pair cables, fiber optic cables, or a combination thereof MCDN 100 may include digital subscribe line (DSL) compliant twisted pair connections between clients 120 and a node (not depicted) in access network 130 while fiber, cable or another broadband medium connects service provider resources to the node. In other embodiments, the broadband cable may extend all the way to clients 120.

As depicted in FIG. 1, switching network 140 provides connectivity for service provider 121, and may be housed in a central office or other facility of service provider 121. Switching network 140 may provide firewall and routing functions to demarcate access network 130 from the resources of service provider 121. In embodiments that employ DSL compliant connections, switching network 140 may include elements of a DSL Access Multiplexer (DSLAM) that multiplexes many subscriber DSLs to backbone network 170.

In FIG. 1, backbone network 170 represents a private network including, as an example, a fiber based network to accommodate high data transfer rates. Content acquisition resources 180 as depicted in FIG. 1 encompass the acquisition of various types of content including broadcast content, other “live” content including national content feeds, and VOD content.

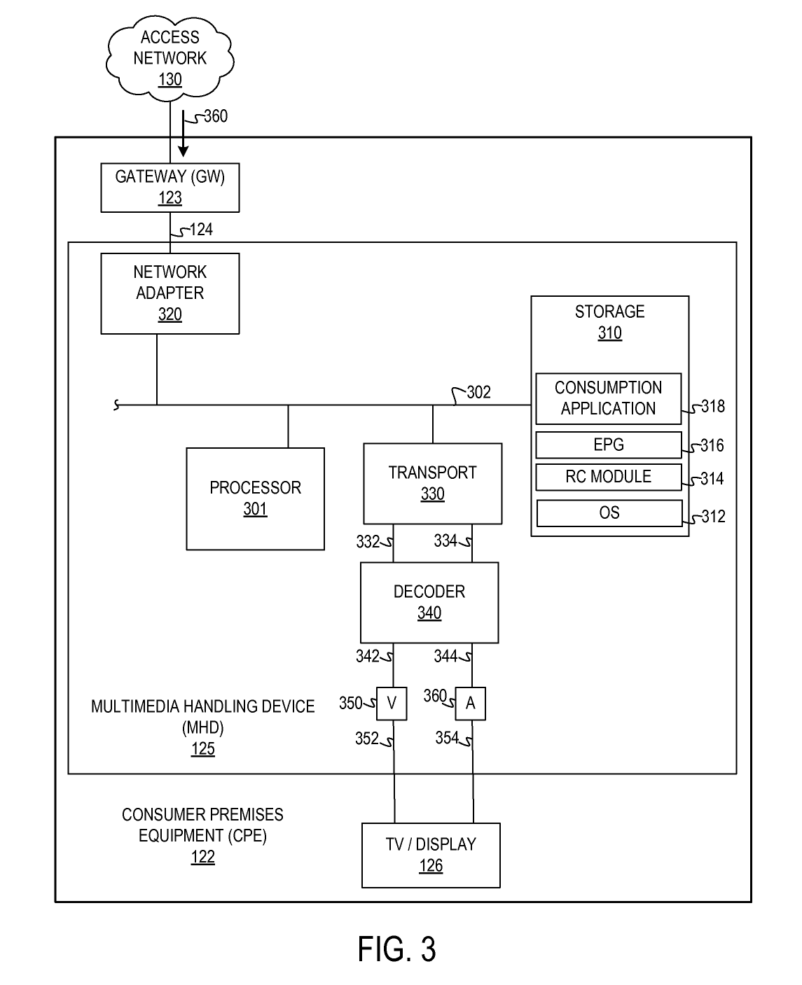

Thus, the content provided by service provider 121 encompasses multimedia content that is scheduled in advance for viewing by clients 120 via access network 130. Such multimedia content, also referred to herein as “scheduled programming,” may be selected using an EPG, such as EPG 316 described below with respect to FIG. 3. Accordingly, a user of MCDN 100 may be able to browse scheduled programming well in advance of the broadcast date and time. Some scheduled programs may be “regularly” scheduled programs, which recur at regular intervals or at the same periodic date and time (i.e., daily, weekly, monthly, etc.).

As will be discussed in detail below, “content selection events” related to multimedia content consumption by the user may be recorded and analyzed. These content selection events, also referred to as “user selection events,” may be “historical events” that include event information collected over a period of consumption and may be correlated with timestamp information. As used herein, “consumption” refers to viewing, listening, recording, copying, obtaining, selecting, or any other actions associated with receipt of multimedia content by the user. A recording of the content selection events themselves may be referred to as a “historical consumption log.” The content selection events may represent multimedia content that has been selected for consumption by the user, along with an actual duration of consumption by the user. Content selection events may selectively be recorded for content provided via the MCDN, or for content provided by other sources, for example, broadcast signals or tangible media.

Additional information indicative of the multimedia content associated with content selection events may be stored in the historical consumption log. Such information may be referred to as “content type” information, such as, channel, channel type, intended audience, genre, duration, time of broadcast, and program ratings, etc. The “channel type,” as referred to herein, may be indicative of PPV, VOD, or scheduled programming, among others.

Acquired content is provided to content delivery server 160 via backbone network 170 and switching network 140. Content may be delivered from content delivery server 160 to clients 120 via switching network 140 and access network 130. Content may be compressed, encrypted, modulated, demodulated, and otherwise encoded or processed at content acquisition resources 180, content delivery server 160, or both. Although FIG. 1 depicts a single element encompassing acquisition of all content, different types of content may be acquired via different types of acquisition resources. Similarly, although FIG. 1 depicts a single content delivery server 160, different types of content may be delivered by different servers. Moreover, embodiments of MCDN 100 may include content acquisition resources in regional offices that are connected to switching network 140.

Although service provider 121 is depicted in FIG. 1 as having switching network 140 to which content acquisition resources 180, content delivery server 160, and application server 150 are connected, other embodiments may employ different switching networks for each of these functional components and may include additional functional components (not depicted in FIG. 1) including, for example, operational subsystem support (OSS) resources.

FIG. 1 also illustrates application server 150 connected to switching network 140. As suggested by its name, application server 150 may host or otherwise implement one or more applications for MCDN 100. Application server 150 may be any data processing system with associated software that provides applications for clients or users. Application server 150 may provide services including multimedia content services, e.g., EPG, digital video recording (DVR), VOD, or PPV, an IPTV portal, digital rights management (DRM) servers, navigation/middleware servers, conditional access systems (CAS), and remote diagnostics, as examples.

Applications provided by application server 150 may be downloaded and hosted on other network resources including, for example, content delivery server 160, switching network 140, and/or on clients 120. Application server 150 is configured with a processor and storage media (not shown in FIG. 1) and is enabled to execute processor instructions, such as those included within a software application. As depicted in FIG. 1, application server 150 may be configured to include consumption analysis application 152, which, as will be described in detail below, is enabled to analyze consumption of multimedia content provided to client 120 of MCDN 100.

Further depicted in FIG. 1 is database server 190, which provides hardware and software resources for data warehousing. Database server 190 may communicate with other elements of the resources of service provider 121, such as application server 150 or content delivery server 160, in order to store and provide access to large volumes of data, information, or multimedia content. In some embodiments, database server 190 includes a data warehousing application, accessible via switching network 140, that can be used to record and access structured data, such as consumption data or patterns generated by analyzing historical logs of multimedia content consumption of clients 120, as will be discussed in detail below.

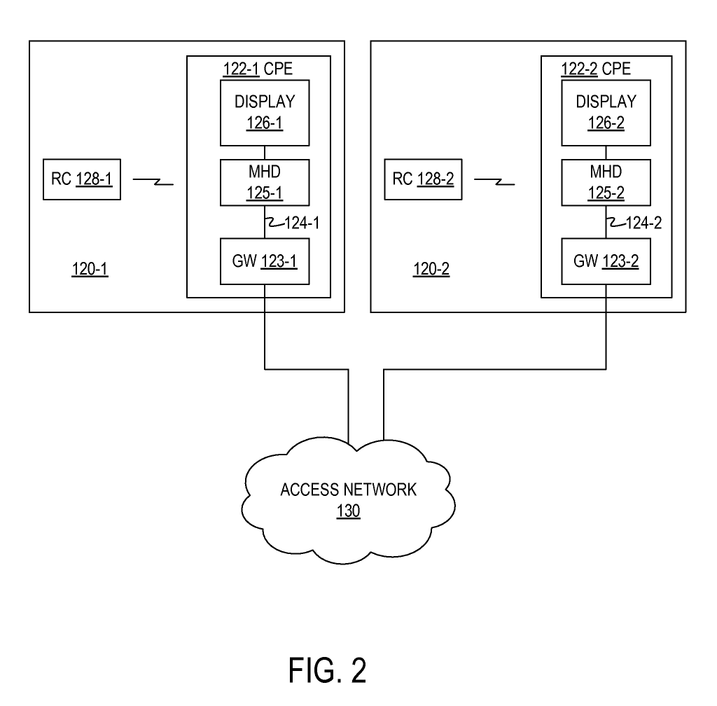

Turning now to FIG. 2, clients 120 are shown in additional detail with respect to access network 130. Clients 120 may include a network appliances collectively referred to herein as CPE 122. In the depicted embodiment, CPE 122 includes the following devices: gateway (GW) 123, multimedia handling device (MHD) 125, and display device 126. Any combination of GW 123, MHD 125, and display device 126 may be integrated into a single physical device. Thus, for example, CPE 122 might include a single physical device that integrates GW 123, MHD 125, and display device 126. As another example, MHD 125 may be integrated into display device 126, while GW 123 is housed within a physically separate device.

In FIG. 2, GW 123 provides connectivity for client 120 to access network 130. GW 123 provides an interface and conversion function between access network 130 and client-side local area network (LAN) 124. GW 123 may include elements of a conventional DSL or cable modem. GW 123, in some embodiments, may further include routing functionality for routing multimedia content, conventional data content, or a combination of both in compliance with IP or another network layer protocol. In some embodiments, LAN 124 may encompass or represent an IEEE 802.3 (Ethernet) LAN, an IEEE 802.11-type (WiFi) LAN, or a combination thereof. GW 123 may still further include WiFi or another type of wireless access point to extend LAN 124 to wireless-capable devices in proximity to GW 123. GW 123 may also provide a firewall (not depicted) between clients 120 and access network 130.

Clients 120 as depicted in FIG. 2 further include a display device or, more simply, a display 126. Display 126 may be implemented as a TV, a liquid crystal display screen, a computer monitor, or the like. Display 126 may comply with a display standard such as NTSC (National Television System Committee), PAL (Phase Alternating Line), or another suitable standard. Display 126 may include one or more integrated or external speakers to play audio content.

Clients 120 are further shown with their respective remote control 128, which is configured to control the operation of MHD 125 by means of a user interface (not shown in FIG. 2) displayed on display 126. Remote control 128 of client 120 is operable to communicate requests or commands wirelessly to MHD 125 using infrared (IR) or radio frequency (RF) signals. MHDs 125 may also receive requests or commands via buttons (not depicted) located on side panels of MHDs 125.

MHD 125 is enabled and configured to process incoming multimedia signals to produce audio and visual signals suitable for delivery to display 126 and any that may be present speakers (not depicted). Incoming multimedia signals received by MHD 125 may be compressed and/or encrypted, digital or analog, packetized for delivery over packet switched embodiments of access network 130 or modulated for delivery over cable-based access networks. In some embodiments, MHD 125 may be implemented as a stand-alone set top box suitable for use in a co-axial or IP-based MCDN.

Referring now to FIG. 3, a block diagram illustrating selected elements of an embodiment of MHD 125 is presented. In FIG. 3, MHD 125 is shown as a functional component of CPE 122 along with GW 123 and display 126, independent of any physical implementation, as discussed above with respect to FIG. 2. In particular, it is noted that CPE 122 may be any combination of GW 123, MHD 125 and display 126.

In the embodiment depicted in FIG. 3, MHD 125 includes processor 301 coupled via shared bus 302 to storage media collectively identified as storage 310. MHD 125, as depicted in FIG. 3, further includes network adapter 320 that interfaces MHD 125 to LAN 124 and through which MHD 125 receives multimedia content 360. GW 123 is shown providing a bridge between access network 130 and LAN 124, and receiving multimedia content 360 from access network 130.

In embodiments suitable for use in IP based content delivery networks, MHD 125, as depicted in FIG. 3, may include transport unit 330 that assembles the payloads from a sequence or set of network packets into a stream of multimedia content. In coaxial based access networks, content may be delivered as a stream that is not packet based and it may not be necessary in these embodiments to include transport unit 330. In a co-axial implementation, however, clients 120 may require tuning resources (not explicitly depicted in FIG. 3) to “filter” desired content from other content that is delivered over the coaxial medium simultaneously and these tuners may be provided in MHDs 125. The stream of multimedia content received by transport unit 330 may include audio information and video information and transport unit 330 may parse or segregate the two to generate video stream 332 and audio stream 334 as shown.

Video and audio streams 332 and 334, as output from transport unit 330, may include audio or video information that is compressed, encrypted, or both. A decoder unit 340 is shown as receiving video and audio streams 332 and 334 and generating native format video and audio streams 342 and 344. Decoder 340 may employ any of various widely distributed video decoding algorithms including any of the Motion Pictures Expert Group (MPEG) standards, Windows Media Video (WMV) standards including WMV 9, which has been standardized as Video Codec-1 (VC-1) by the Society of Motion Picture and Television Engineers. Similarly decoder 340 may employ any of various audio decoding algorithms including Dolby® Digital, Digital Theatre System (DTS) Coherent Acoustics, and Windows Media Audio (WMA).

The native format video and audio streams 342 and 344 as shown in FIG. 3 may be processed by encoders/digital-to-analog converters (encoders/DACs) 350 and 360 respectively to produce analog video and audio signals 352 and 354 in a format compliant with display 126, which itself may not be a part of MHD 125. Display 126 may comply with NTSC, PAL or any other suitable television standard.

Storage 310 encompasses persistent and volatile media, fixed and removable media, and magnetic and semiconductor media. Storage 310 is operable to store instructions, data, or both. Storage 310 as shown includes sets or sequences of instructions, namely, an operating system 312, a remote control application program identified as RC module 314, EPG 316, and a consumption application 318. Operating system 312 may be a UNIX or UNIX-like operating system, a Windows® family operating system, or another suitable operating system. In some embodiments, storage 310 is configured to store and execute instructions provided as services to client 120 by application server 150, as mentioned previously.

EPG 316 represents a guide to the multimedia content provided to client 120 via MCDN 100, and may be shown to the user as an element of the user interface. The user interface may include a plurality of menu items arranged according to one or more menu layouts, which enable a user to operate MHD 125. The user may operate the user interface, including EPG 316, using remote control 128 (see FIG. 2) in conjunction with RC module 314. In some embodiments, consumption analysis application 152, in conjunction with EPG 316 and consumption application 318, provides functionality to record content selection events and analyze the events to generate consumption statistics, as well as, enable the user to access the consumption statistics for display, as will now be described in further detail below.

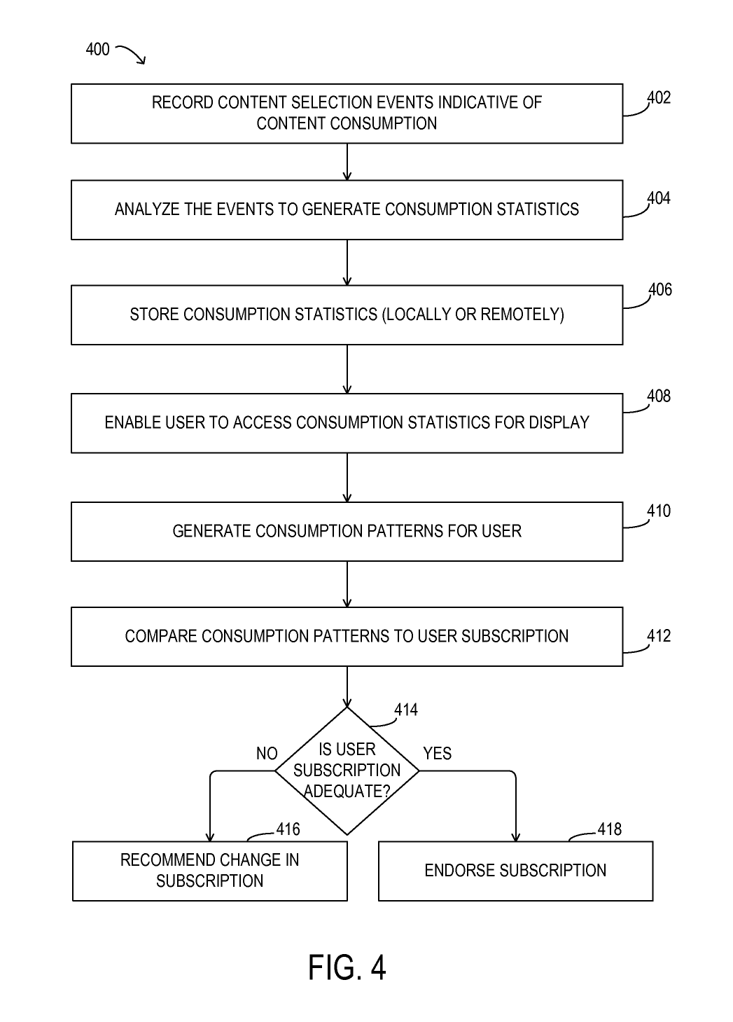

Referring now to FIG. 4, one embodiment of a method 400 for analyzing the consumption of multimedia content provided by MCDN 100 to clients 120 is depicted. Accordingly, method 400 may be executed in a continuous or intermittent manner across a large number of clients 120. It is noted that consumption application 318, alone or in combination with consumption analysis application 152, may be configured to execute method 400. It is further noted that the operations depicted in FIG. 4 may be rearranged, duplicated, or omitted in various embodiments of method 400.

In FIG. 4, content selection events indicative of multimedia content consumption by the user may be recorded (operation 402). The recording in operation 402 may result from user selection events generated by an EPG, while a user selects content using the EPG. A historical consumption log for the user may be recorded by CPE 122, in operation 402. The content selection events may be analyzed to generate consumption statistics for the user (operation 404). “Consumption statistics,” also referred to as “content consumption data,” refers to data describing user consumption of multimedia, which may be the result of statistical analysis. In some implementations, the analysis in operation 404 is performed locally by CPE 122. In other cases, the historical consumption log is sent to a remote server, for example application server 150, for analysis in operation 404. The consumption statistics may be stored, either locally by CPE or remotely by a server (operation 406). The consumption statistics may reveal user consumption patterns indicative of the content type consumed by the user over time, as will be discussed below.

Method 400 may then enable the user to access consumption statistics for display (operation 408). An EPG may be used to access and display consumption statistics on CPE in operation 408. In some embodiments, EPG 316, provided by CPE 122, is configured to record user selection events, as in operation 402, and to display consumption statistics and other related information to the user, as in operation 408. EPG 316 may display consumption statistics on a specially designed user interface, such as a separate page or screen view, on display 126.

Method 400 may then generate consumption patterns for the user (operation 410). The consumption patterns may be generated locally by CPE or by a server in operation 410, using the consumption statistics previously generated in method 400. The consumption patterns may describe, either visually or numerically, which content types the user consumes during a given time period.

The consumption statistics, or patterns, may then be compared with a subscription for multimedia content held by the user (operation 412). The subscription may be for multimedia content provided by MCDN 100. In operation 412, a monetary value associated with actual content consumed by the user may be compared with the monetary value of the subscription. A consumption metric may be generated based on the comparison in operation 412. In some embodiments, the consumption metric may be a numerical value, such as a positive or negative percentage, or an enumerated value from a list, such as “undersubscribed”, “oversubscribed”, or “adequately subscribed”.

In an exemplary implementation, undersubscribed, or a negative value, may indicate to the user that a more expansive subscription would better match the viewer's actual consumption habits, and may provide a net savings based on historical consumption. Similarly, oversubscribed, or a positive value, may indicate that that the user is not making the best use of the current subscription, and that a more restrictive subscription would suffice based on historical consumption. Accordingly, adequately subscribed, or a near zero value, may indicate that the user's current subscription is well matched to historical consumption. It is noted that the above example may be substituted for other forms of comparison, or may be selectively applied to individual content types and then aggregated, in different embodiments.

In method 400, a decision whether or not the user subscription is adequate may then be made (operation 414). In some embodiments, the decision in operation 414 is based on the consumption metric described above. If the result of the decision in operation 414 is YES, then the user's current subscription may be endorsed (i.e., validated as being in line with the user's consumption habits) (operation 418). If the result of the decision in operation 414 is NO, then the a corresponding change in the user's subscription may be recommended (operation 416). In some embodiments, a monetary value indicating the savings the user may accrue by accepting the recommendation in operation 416 is displayed to the user.

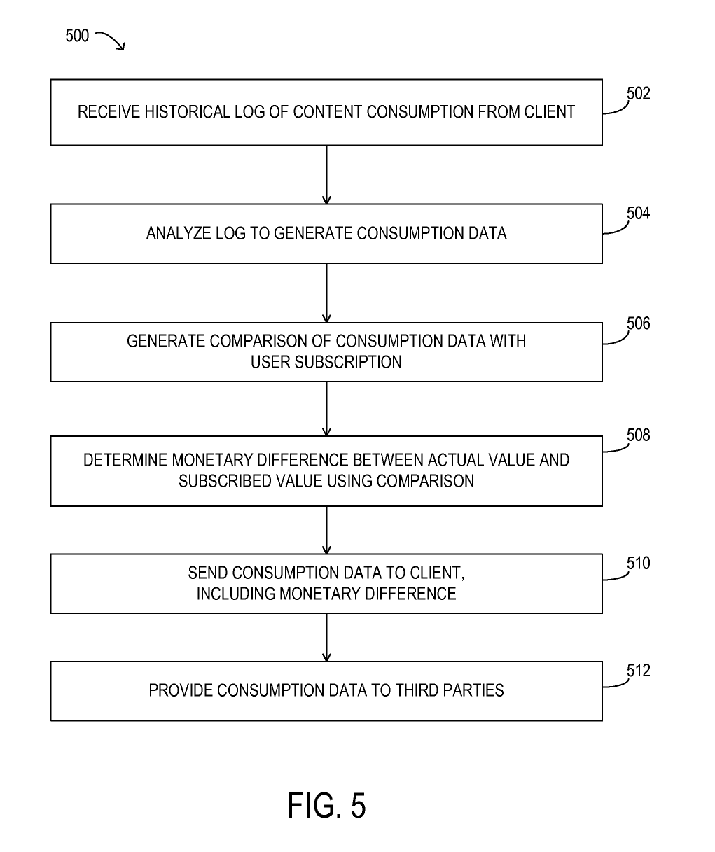

Referring now to FIG. 5, one embodiment of a method 500 for analyzing the consumption of multimedia content provided by MCDN 100 to clients 120 is depicted. Accordingly, method 500 may be executed in a continuous or intermittent manner across a large number of clients 120. It is noted that consumption analysis application 152, alone or in combination with consumption application 318, may be configured to execute method 500. It is further noted that the operations depicted in FIG. 5 may be rearranged, duplicated, or omitted in various embodiments of method 500.

In FIG. 5, a historical log of content consumption is received from a client (operation 502). The historical log may represent content selection events for the user associated with the client. The historical log may be analyzed to generate consumption data (operation 504). A comparison of the consumption data with a user subscription is generated (operation 506). In some embodiments, the consumption data is compared with a plurality of available subscriptions and a respective plurality of comparison results may be generated in operation 506.

Next in method 500, a monetary difference between the actual value of multimedia content consumed by the user and the value of a user subscription is determined (operation 508). In one illustrative example, the user may have consumed supplementary PPV programs for a total of $48 in the last month, in addition to paying a base subscription package costing $12 per month. Thus, a total cost of $60 per month as an actual consumption value and $12 a month as the value of the user subscription, yielding a monetary difference of $48, may be determined in operation 508. In this case, the actual consumption is determined for the user in operation 508.

In a different example, an actual consumption of $60 for the past month may be compared with an extended subscription costing $36 per month, in operation 506. The extended subscription, however, includes unlimited access to the PPV programs selected by the user in the last month which alone cost $48. In this case, a total cost of $60 per month as an actual consumption value may be compared with the subscription value of $36 per month, yielding a monetary difference of negative $24, or a net savings for the extended subscription, in operation 508. In this example, the actual consumption is analyzed relative to a different subscription in operation 508.

The consumption data including the monetary difference may then be sent to the client (operation 510). As discussed above with respect to operation 416 in FIG. 4, a recommendation for a different subscription may be determined in operation 510. In some embodiments, information, including the comparison and/or monetary difference, is sent to the client in the form of a page in an EPG, such as a hypertext markup language (HTML) document, in operation 510.

Method 500 may then provide consumption data for one or more clients to third parties (operation 512). In some cases, third parties may perform data mining on the consumption data for a plurality of clients, in order to perform market analyses, program ratings evaluations, advertising analyses, etc, using the data provided in operation 512. It is also noted that operation 512 may include monetization of access to consumption data provided to third parties.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for analyzing multimedia content provided by a multimedia content delivery network (MCDN), the method comprising:
collecting historical events describing multimedia content selected by a user of the MCDN;
analyzing the historical events to generate consumption statistics specific to the user;
storing the consumption statistics; and
enabling the display of the consumption statistics.

2. The method of claim 1, wherein the MCDN is an Internet protocol compliant network.

3. The method of claim 1, wherein said collecting, analyzing, and enabling are performed by customer premises equipment.

4. The method of claim 1, wherein the selected multimedia content is selected using an electronic programming guide (EPG), and wherein the consumption statistics are accessible using the EPG.

5. The method of claim 1, further comprising:
evaluating the consumption statistics with respect to an MCDN subscription package; and
generating a consumption metric based at least in part on said evaluating, wherein the consumption metric indicates a relationship between the consumption statistics and the MCDN subscription package.

6. The method of claim 5, further comprising:
recommending a modification of the MCDN subscription package to the user based on the consumption metric.

7. The method of claim 6, wherein the consumption metric indicates at least one of undersubscribed, oversubscribed, or adequately subscribed.

8. The method of claim 1, wherein analyzing said historical events includes classifying the selected multimedia content based on content type.

9. The method of claim 8, wherein the content type is selected from the group consisting of: channel, channel type, intended audience, genre, duration, time of broadcast, and program ratings.

10. The method of claim 9, wherein the channel type is at least one of: pay per view, video on demand, and scheduled programming.

11. A device, configured to analyze multimedia content provided by a multimedia content delivery network (MCDN), the device comprising:
a processor;
a network interface configured to receive multimedia content from the MCDN; and
memory media accessible to the processor, including processor executable instructions to:
record multimedia content user selection events to a historical consumption log;
process the historical consumption log to reveal user consumption patterns; and
display information visually indicative of the user consumption patterns.

12. The device of claim 11, further comprising:
a display device; and
further including processor executable instructions to:
display a comparison of the user consumption patterns and an MCDN subscription package purchased by the user.

13. The device of claim 12, wherein an electronic programming guide (EPG) of the MCDN is used to generate the user selection events.

14. The device of claim 12, wherein an EPG of the MCDN is used to display said information visually.

15. The device of claim 14, wherein the comparison is made available by accessing the EPG.

16. The device of claim 12, wherein a result of the comparison is at least one of undersubscribed, oversubscribed, or adequately subscribed.

17. The device of claim 11, wherein said processor executable instructions to process the historical consumption log include instructions executable to:
send the historical consumption log to a remote server for analysis; and
receive results of the analysis from the remote server, wherein the results include user consumption patterns.

18. The device of claim 11, wherein said processor executable instructions to process the historical consumption log include instructions executable to:
analyze the historical consumption log locally using the processor.

19. Computer-readable memory media, including program instructions for analyzing multimedia content provided to a user via a multimedia content delivery network (MCDN), said program instructions executable to:
receive a historical consumption log, wherein the historical consumption log includes information indicative of which multimedia content was selected for viewing by the user;
analyze the historical consumption log and generate content consumption data based on the analysis; and
send the content consumption data to a client of the MCDN.

20. The memory media of claim 19, wherein the content consumption data includes a comparison of actual consumption by the user with an MCDN subscription package purchased by the user.

21. The memory media of claim 20, wherein the comparison further includes a monetary difference between the value of the actual consumption and the value of the MCDN subscription package.

22. The memory media of claim 20, wherein the comparison further includes information about different categories of multimedia content.

23. The memory media of claim 22, wherein the categories of content are selected from the group consisting of: channel, channel type, intended audience, genre, duration, time of broadcast, and program ratings.

24. The memory media of claim 19, further including program instructions executable to:
include the content consumption data in an electronic programming guide provided to the client.

25. The memory media of claim 19, further including program instructions executable to:
provide the content consumption data to a third party for data mining.
